(19) United States
(12) Patent Application Publication
(10) Pub. No.: US 2015/0289532 A1
(43) Pub. Date: Oct. 15, 2015

(54) METHOD FOR PRODUCING PROCESSED CHEESE

(71) Applicant: MORINAGA MILK INDUSTRY CO., LTD., Minato-ku, Tokyo (JP)

(72) Inventors: Akira Chiba, Zama-shi (JP); Hiroshi Koishihara, Zama-shi (JP)

(73) Assignee: MORINAGA MILK INDUSTRY CO., LTD., Minato-ku, Tokyo (JP)

(21) Appl. No.: 14/441,609

(22) PCT Filed: Mar. 28, 2014
(86) PCT No.: PCT/JP2014/059223

§ 371 Date: May 8, 2015

(30) Foreign Application Priority Data
Mar. 29, 2013 (JP) 2013-073149

(51) Int. Cl. A23C 19/05; A23C 19/08

(52) U.S. Cl. CPC A23C 19/052; A23C 19/08

(57) ABSTRACT

A processed cheese is produced by producing a natural cheese (N) via an acidification step, a coagulation step and a dehydration step described below, and then using the obtained natural cheese (N) for at least 5% by mass of an ingredient cheese. The acidification step is a step of acidifying a milk to obtain an acidified milk having a pH of 5.8 to 6.4, in which an acid component is added to the milk to achieve the required pH for the acidified milk, the coagulation step is a step of obtaining a curd by adding a milk coagulating enzyme to the acidified milk to cause coagulation, without adding a lactic acid bacterium starter, and the dehydration step is a step of obtaining the natural cheese (N) by separating whey from the curd, and includes an enzyme inactivation step of inactivating the milk coagulating enzyme by cooking the curd to at least 55° C. at a rate of temperature increase of not more than 1° C. per minute.

### TECHNICAL FIELD

The present invention relates to a method for producing processed cheese. Priority is claimed on Japanese Patent Application No. 2013-073149, filed Mar. 29, 2013, the content of which is incorporated herein by reference.

### BACKGROUND ART

Processed cheese uses one, or two or more, natural cheeses as ingredients for the processed cheese, and is produced by cooking, melting and emulsifying these ingredients.

It is known that the quality and amount of casein within the natural cheese used as an ingredient of the processed cheese contributes to the hardness of the processed cheese. In order to increase the hardness of the processed cheese, a natural cheese containing a large amount of non-degraded casein (also referred to as intact casein) is used as an ingredient.

Natural cheese is usually produced by a method which includes adding a lactic acid bacterium starter and a milk coagulating enzyme (also called rennet) to a milk, coagulating the milk to form a curd, separating the whey from the mixture of the curd and whey, subsequently salting, molding and pressing the curd to obtain a green cheese (meaning a young natural cheese), and then maturing this green cheese in an atmosphere which satisfies specific temperature conditions and humidity conditions. Maturation of a cheese refers to the degradation, without rotting, of the protein, fat, and carbohydrate and the like within the milk under the action of enzymes and microbes and the like, resulting in the development of a special flavor. The maturation step is conducted in an environment that facilitates the action of the enzymes and microbes and the like.

From the viewpoint of satisfactorily imparting hardness to the processed cheese, the natural cheese used for imparting the hardness is preferably a natural cheese in which degradation of the casein has not yet progressed, and therefore a natural cheese that has been produced without performing a maturation step is preferable.

Japanese Unexamined Patent Application, First Publication No. Hei 09-094063 (also referred to as Patent Document 1) discloses the production of a natural cheese without performing a maturation step, and although not produced as an ingredient for a processed cheese, a method for producing a processed cheese using this natural cheese is also disclosed.

In a method specifically disclosed in Example 1 of Patent Document 1, first, a concentrated milk in which the casein micelle concentration has been adjusted to a specific value is adjusted to a temperature of 20° C., rennet is added, and following reaction for 10 minutes, lactic acid is added and the pH is adjusted to 5.5. This mixture is then poured into hot water at 80° C. to produce a curd, and the produced curd is dehydrated while undergoing kneading, yielding a curd having a moisture content of 45 to 50% by weight. Emulsifying salts are added to the obtained curd, cooking and emulsifying is performed so that a temperature of 90° C. is reached, thus obtaining an emulsified product, and this emulsified product is cooled for an entire day at 5° C. to obtain a rice cake-like processed cheese.

Further, Japanese Unexamined Patent Application, First Publication No. 2011-109984 (also referred to as Patent Document 2) discloses a method for producing a pasteurized natural cheese by forming a curd and then performing heat pasteurization, or a method for producing a pasteurized natural cheese by performing heat pasteurization without adding emulsifying salts to a natural cheese, wherein the heat pasteurization is performed, for example, at a temperature of 70 to 90° C., and following inactivation of the microbes and enzymes derived from the ingredients, a lactic acid bacterium is added.

Moreover, U.S. Patent Application Publication No. 2006/0057249 (also referred to as Patent Document 3) discloses a method for the fast production of cheese curds for use as ingredients in processed cheese, wherein the method uses a cheese vat equipped with a steam injection mechanism.

### CITATION LIST

### Patent Documents

Patent Document 1: Japanese Unexamined Patent Application, First Publication No. Hei 09-094063

Patent Document 2: Japanese Unexamined Patent Application, First Publication No. 2011-109984

Patent Document 3: U.S. Patent Application Publication No. 2006/0057249.

### SUMMARY OF THE INVENTION

### Problems to be Solved by the Invention

From the viewpoint of structural stability, the natural cheese used for increasing the hardness of a processed cheese is preferably not a cheese that has just been produced, but is rather a cheese that has been stored at low temperature for a period of several weeks to several months, but from the viewpoint of satisfactorily imparting hardness to the processed cheese, a natural cheese that has been produced with suppressed maturation is preferable.

A natural cheese produced without a maturation step in order to suppress the degradation of casein is preferably stored, prior to being used in the production of a processed cheese, in an environment in which degradation of the casein due to the action of enzymes and microbes and the like is suppressed.

Examples of methods which can be used for this purpose include a method in which enzyme activity is reduced by lowering the moisture content of the natural cheese, a method in which the moisture activity is reduced by increasing the salt concentration of the natural cheese, thereby reducing microbe growth and enzyme activity, a method in which the storage temperature is set lower than normal refrigeration temperature (for example, a temperature within a range from 0 to -2° C.), thereby reducing microbe growth and enzyme activity, and methods which represent a combination of the above methods.

However, according to the findings of the inventors of the present invention and others, even when these methods are used, changes over time in the physical properties of natural cheese during the storage period cannot be satisfactorily prevented.

Specifically, the viscosity upon cooking and melting the cheese in the cooking and emulsification step (hereafter referred to as the melting viscosity) decreases as the storage period for the natural cheese lengthens, and therefore a problem arises in that when the melting viscosity of the natural cheese decreases, the hardness of the obtained processed cheese also decreases.

The present invention has been developed in light of the above circumstances, and has an object of suppressing any decrease in the melting viscosity during storage of a natural cheese used as an ingredient for a processed cheese, and improving the production stability of a processed cheese having favorable hardness.

### Means to Solve the Problems

In order to achieve the above object, a method for producing a processed cheese according to the present invention has a cooking and emulsification step of adding an emulsifying salt to an ingredient cheese containing at least one type of natural cheese, and then performing cooking and emulsifying, in which

a natural cheese (N) is produced via an acidification step, a coagulation step and a dehydration step described below, and the cooking and emulsification step is performed using the obtained natural cheese (N) for at least 5% by mass of the total mass of the ingredient cheese, wherein

the acidification step is a step of acidifying a milk to obtain an acidified milk having a pH of 5.8 to 6.4, in which an acid component is added to the milk to achieve the above pH for the acidified milk, the coagulation step is a step of obtaining a curd by adding a milk coagulating enzyme to the acidified milk to cause coagulation, without adding a lactic acid bacterium starter, and the dehydration step is a step of obtaining the natural cheese (N) by separating the whey from the curd, and includes an enzyme inactivation step of inactivating the milk coagulating enzyme by cooking the curd to at least 55° C.

In the dehydration step, separation of the whey is preferably performed so that the moisture content of the obtained natural cheese (N) is from 35 to 40% by mass.

The cooking performed in the dehydration step is preferably performed using an indirect heating method.

The inactivation temperature for the milk coagulating enzyme is preferably from 55 to 65° C.

The acid component is preferably an aqueous solution of one or more organic acids selected from the group consisting of citric acid, lactic acid and acetic acid.

The pH at 25° C. of the natural cheese (N) obtained in the dehydration step is preferably from 5.6 to 6.4.

The natural cheese (N) obtained in the dehydration step is preferably stored at a temperature of not more than 10° C. for 10 to 180 days and followed by being used in the cooking and emulsification step.

The enzyme inactivation step of inactivating the milk coagulating enzyme by cooking the curd to at least 55° C. is preferably an enzyme inactivation step of inactivating the milk coagulating enzyme by cooking the curd to at least 55° C. at a rate of temperature increase of not more than 1° C. per minute.

In other words, the present invention has the following aspects.
(1) A method for producing a processed cheese having a cooking and emulsification step of adding an emulsifying salt to an ingredient cheese containing at least one type of natural cheese and then performing cooking and emulsifying, in which

a natural cheese (N) is produced via an acidification step, a coagulation step and a dehydration step described below, and

the cooking and emulsification step is performed using the obtained natural cheese (N) for at least 5% by mass of the ingredient cheese, wherein

the acidification step is a step of acidifying a milk to obtain an acidified milk having a pH of 5.8 to 6.4, in which an acid component is added to the milk to achieve the pH for the acidified milk,

the coagulation step is a step of obtaining a curd by adding a milk coagulating enzyme to the acidified milk to cause coagulation, without adding a lactic acid bacterium starter, and

the dehydration step is a step of obtaining the natural cheese (N) by separating whey from the curd, and includes an enzyme inactivation step of inactivating the milk coagulating enzyme by cooking the curd to at least 55° C. at a rate of temperature increase of not more than 1° C. per minute.
(2) The method for producing a processed cheese according to (1), wherein in the dehydration step, separation of the whey is performed so that the moisture content of the obtained natural cheese (N) is from 35 to 40% by mass relative to the total mass of the natural cheese (N).
(3) The method for producing a processed cheese according to (1) or (2), wherein the cooking performed in the dehydration step is indirect heating.
(4) The method for producing a processed cheese according to any one of (1) to (3), wherein the inactivation temperature for the milk coagulating enzyme is from 55 to 65° C.
(5) The method for producing a processed cheese according to any one of (1) to (4), wherein the acid component is an aqueous solution of one or more organic acids selected from the group consisting of citric acid, lactic acid and acetic acid.
(6) The method for producing a processed cheese according to any one of (1) to (5), wherein the pH at 25° C. of the natural cheese (N) obtained in the dehydration step is from 5.6 to 6.4.
(7) The method for producing a processed cheese according to any one of (1) to (6), wherein the cooking and emulsifying is performed after the natural cheese (N) obtained in the dehydration step has been stored at a temperature of not more than 10° C. for 10 to 180 days.

### Effects of the Invention

According to the present invention, a natural cheese can be obtained which has a high melting viscosity when subjected to cooking and melting and is resistant to any decrease in the melting viscosity during storage, and by producing a processed cheese using this natural cheese, a processed cheese having favorable hardness can be produced with good stability.

Further, according to the present invention, because a natural cheese can be produced without using a lactic acid bacterium starter, the risk of infection due to bacteriophage can be avoided even if a step of performing heat pasteurization is not provided following curd formation.

### BRIEF DESCRIPTION OF THE DRAWINGS

FIG. 1 is a graph illustrating the measurement results from a series of examples, and illustrates the relationship between the storage period and the melting viscosity for natural cheeses.

FIG. 2 is a graph illustrating the measurement results from a series of examples, and illustrates the relationship between the storage period and the melting viscosity for natural cheeses.

### EMBODIMENTS FOR CARRYING OUT THE INVENTION

### <Processed Cheese>

Processed cheese is prescribed in the following manner by a ministerial ordinance (“Ministerial Ordinance on Milk and Milk products Concerning Compositional Standards, etc.”, Ministry of Health and Welfare Ordinance No. 52, Dec. 27, 1951).

Specifically, “processed cheese” means a product which is made using at least one type of natural cheese, either with or without the addition of additives approved by the Food Sanitation Act, by grinding, mixing, cooking and melting, and emulsification, wherein the milk solids content is at least 40% by mass. Products having a milk solids content of less than 40% by mass are classified as “cheese foods”.

Further, in the Fair Competition Code (based on the agreements and protocols of Article 11 of the Act against Unjustifiable Premiums and Misleading Representations), processed cheese is described as a product having a milk solids content (the total mass of milk fat and milk protein) of at least 40% by mass, which may also contain, as additional components besides the natural cheese(s), cream, butter or butter oil for regulating the fat content. Processed cheese may also contain water. Other additional components include foodstuffs added for the purpose of imparting flavor, fragrance, nutrients, functionality or physical properties, and these may be included in an amount totaling not more than ⅙ of the total solid content weight of the product. In those cases where milk or the like other than the aforementioned cream, butter or butter oil is added as an aforementioned additional component, the lactose content must not exceed 5% by mass, and the amount added must be not more than ⅙ of the total solid content weight of the product.

In the present description, a “processed cheese” preferably satisfies the prescriptions within the aforementioned Ministerial Ordinance on Milk and Milk products Concerning Compositional Standards, etc. and the Fair Competition Code. In other words, in the present description, a “processed cheese” is preferably produced using at least one type of natural cheese, either with or without the addition of additives permissible as food additives, by grinding, mixing, cooking and melting, and emulsification, and the processed cheese preferably has a milk solids content of at least 40% by mass relative to the total mass of the processed cheese, may include water, and may also include, as additional components besides the natural cheese(s), cream, butter or butter oil for regulating the fat content, and other foodstuffs added for the purpose of imparting flavor, fragrance, nutrients, functionality or physical properties, in an amount totaling not more than ⅙ of the total mass of the solid content of the processed cheese, provided that the lactose content in the processed cheese does not exceed 5% by mass relative to the total mass of the processed cheese, and the amount of these other foodstuffs is not more than ⅙ of the total mass of the solid content of the processed cheese.

Definitions of the aforementioned cream, butter and butter oil comply with the aforementioned Ministerial Ordinance on Milk and Milk products Concerning Compositional Standards, etc.

### <<Production Steps for Natural Cheese (N)>>

In the present description, a “natural cheese” means a natural cheese as defined in the aforementioned Ministerial Ordinance on Milk and Milk products Concerning Compositional Standards, etc.

In the method for producing a processed cheese according to the present invention, the use of a natural cheese produced using a specific production method is a feature of the invention. In this description, a natural cheese produced using this specific production method is referred to as a “natural cheese (N)” for the sake of convenience.

The method for producing a processed cheese according to the present invention is a method in which a natural cheese (N) produced by the specific production method is used as at least a portion of the ingredients for the ingredient cheese.

The method for producing a natural cheese (N) is basically a method of adding an acid component to an ingredient cheese, adding a milk coagulating enzyme, and separating the obtained curd from the whey to obtain the natural cheese (N).

First is a description of the steps for producing the natural cheese (N).

### <Cheese Ingredients>

Conventional animal milk typically used as a cheese ingredient, or concentrated milk prepared by concentrating such animal milk can be used as a cheese ingredient for use in the production of the natural cheese (N). If necessary, a milk that has been subjected to a homogenization treatment may also be used.

The milk is preferably a milk (raw milk, cow's milk, special milk, raw goat's milk, raw sheep's milk, pasteurized goat's milk, partially skimmed milk, skimmed milk, or processed milk or the like) as defined in the ministerial ordinance (“Ministerial Ordinance on Milk and Milk products Concerning Compositional Standards, etc.”, Ministry of Health and Welfare Ordinance No. 52, Dec. 27, 1951), but other typical animal milks known as cheese ingredients such as buffalo milk and camel milk may also be used.

When cow's milk is used, whole milk which has undergone no adjustment of the components is generally used, but a milk in which some adjustment of components such as the fat content has been made in order to improve the flavor or in accordance with the intended use may also be used as the cheese ingredient. For example, a milk in which a separator or the like has been used to separate the fat may be used, or a milk in which separated cream has been added to adjust the fat content may be used.

In the present invention, a milk is preferably used as the cheese ingredient, and particularly in those cases where the product is designed to replace a conventional cheese, a raw milk or partially skimmed milk or the like is preferable in terms of composition.

### <Milk Coagulating Enzyme>

Examples of the milk coagulating enzyme used in the production of the natural cheese (N) include rennet derived from animals (such as cows, goats and sheep), microbial rennet, plant-derived rennet and genetically modified rennet, and commercially available rennets typically used in cheese production can be used. Rennet usually has an optimum pH in the acidic region.

In the present invention, either a microbial rennet or a cow-derived rennet can be used, provided the enzyme activity of the rennet can be satisfactorily inactivated in the dehydration step in the production method of the present invention described below. In terms of undergoing inactivation at comparatively low cooking temperatures, the use of a rennet having an enzyme inactivation temperature of 55 to 65° C. is preferable.

Examples of microbial rennets or cow-derived rennets having an enzyme inactivation temperature of 55 to 65° C. include Fromase XLG (a product name, manufactured by DSM N.V.), Hannilase XL (a product name, manufactured by Chr. Hansen A/S), and Naturen Standard Plus (a product name, manufactured by Chr. Hansen A/S).

### <Acid Component>

In the present invention, an acid component is added to the cheese ingredient used in the production of the natural cheese (N) to adjust the pH to a prescribed value.

Any of the known acid components added during cheese production can be used appropriately as the acid component.

For example, an aqueous solution of one or more organic acids selected from the group consisting of citric acid, lactic acid and acetic acid is preferable. In terms of needing only the addition of a comparatively small amount, an aqueous solution of citric acid is particularly preferable.

The concentration of the aqueous solution of the organic acid is preferably from 5 to 60% by mass, and more preferably from 10 to 50% by mass, of the organic acid relative to the total mass of the aqueous solution of the organic acid.

### <Method for Producing Natural Cheese (N)>

### [Acidification Step]

First, the milk-derived cheese ingredient is acidified to obtain an acidified milk having a pH of 5.8 to 6.4.

In the present invention, the acidification of the cheese ingredient is performed by adding the acid component to the cheese ingredient. A lactic acid bacterium starter is not added in the present invention. In other words, the acid component is added to the cheese ingredient in an amount sufficient to obtain the targeted pH for the acidified milk. The pH of raw cow's milk is typically from 6.5 to 6.7.

The melting viscosity obtained upon cooking and melting the obtained natural cheese (N) (hereafter referred to as the melting viscosity of the natural cheese (N)) varies depending on the pH value of the acidified milk.

In the present invention, by adjusting the pH of the acidified milk to a value of 5.8 to 6.4, a favorable melting viscosity is obtained for the natural cheese (N), and any decrease in the melting viscosity of the natural cheese (N) due to a long storage period for the natural cheese (N) can be favorably suppressed. The pH of the acidified milk is preferably from 5.8 to 6.4, and more preferably from 6.0 to 6.2.

One aspect of the acidification step in the present invention is a step in which an aqueous solution of an organic acid, and preferably an aqueous solution of citric acid, having a concentration of 5 to 60% by mass, and preferably 10 to 50% by mass, of the organic acid relative to the total mass of the aqueous solution of the organic acid is added to the cheese ingredient to adjust the pH of the cheese ingredient to a value of 5.8 to 6.4, and preferably a value of 6.0 to 6.2.

A pasteurized milk which has been subjected to heat pasteurization in advance is preferably used as the cheese ingredient. Typically known methods for pasteurizing cheese ingredients used in the production of natural cheeses include the LTLT method (Low Temperature Long Time pasteurization method, namely a method in which the cheese ingredient is held at 62 to 65° C. for at least 30 minutes) and the HTST method (High Temperature Short Time pasteurization method, namely a method in which the cheese ingredient is held at 72 to 75° C. for at 15 seconds), and any known technique may be used as appropriate.

When the cheese ingredient is subjected to heat pasteurization, the temperature of the cheese ingredient at the completion of the heat pasteurization is preferably cooled to a temperature lower than the cooking temperature used in the dehydration step described below, and the addition of the acid component is preferably performed with the temperature held at a constant temperature. One aspect of the present invention involves obtaining the acidified milk by cooling the cheese ingredient that has completed heat pasteurization, for example to a temperature of about 35 to 50° C., and then adding the acid component while the temperature is held within this range.

Further, it is preferable that the acid component is added to the cheese ingredient that has completed heat pasteurization, calcium chloride is then added and stirred for a predetermined period, and the milk coagulating enzyme is then added. Either the acid component or the calcium chloride may be added first, or the two components may be added simultaneously.

The coagulation rate caused by the milk coagulating enzyme is affected by the calcium content within the cheese ingredient.

When a pasteurized milk that has already undergone heat pasteurization is used as the cheese ingredient, because a portion of the calcium is insolubilized by the heating, it is preferable that sufficient calcium chloride is added to the pasteurized milk to at least replenish this insolubilized calcium.

When calcium chloride is added to the cheese ingredient, if the amount added of the calcium chloride is too small, then the coagulation is delayed, whereas if the amount added is too large, then the flavor and structure tend to deteriorate. Accordingly, when calcium chloride is added to the cheese ingredient, the amount added is preferably set within a range that does not cause these types of problems.

For example, the calcium chloride content relative to the volume of the cheese ingredient (pasteurized milk) is preferably from 0.005 to 0.2% by volume, and more preferably from 0.01 to 0.1% by volume.

The time from the addition of the calcium chloride until the addition of the milk coagulating enzyme, namely the stirring time following addition of the calcium chloride, is preferably at least 5 minutes in terms of facilitating uniform dispersion, and in terms of the production efficiency, is preferably not more than 60 minutes, more preferably not more than 40 minutes, and particularly preferably 10 minutes or less.

### [Coagulation Step]

A milk coagulating enzyme is added to the acidified milk obtained in the acidification step, thereby coagulating the cheese ingredient to obtain a curd. It is preferable that the milk coagulating enzyme is added to the acidified milk, which has undergone heat pasteurization and the addition of calcium chloride and is being held at a constant temperature, thereby coagulating the milk to obtain a curd.

One aspect of the present invention involves adding the milk coagulating enzyme to the acidified milk, and following stirring to achieve a uniform mixture, leaving the mixture to stand at a constant temperature to form the curd.

If the amount added of the milk coagulating enzyme is too small, then considerable time is required for the coagulation and the efficiency deteriorates, whereas if the amount added is too large, then there is a possibility that the quality may deteriorate as a result of non-uniform coagulation or overly rapid coagulation. Accordingly, the amount added of the milk coagulating enzyme is preferably set so that these types of problems do not occur.

The amount added of the milk coagulating enzyme is preferably from 5 to 600 ppm, and more preferably from 10 to 500 ppm, relative to the total volume of the acidified milk.

The standing time following addition of the milk coagulating enzyme may be any time sufficient to produce adequate coagulation of the acidified milk. For example, the standing time is preferably about 15 to 60 minutes, and more preferably 20 to 40 minutes.

The temperature during the standing period following the addition of the milk coagulating enzyme is, for example, preferably from 30 to 50° C., and more preferably from 35 to 45° C.

### [Dehydration Step]

The whey is separated from the curd and whey mixture obtained in the coagulation step, thus obtaining a natural cheese (N).

In the present invention, the dehydration step includes separating the whey from the curd and whey mixture obtained in the coagulation step, and the actual separation of the whey can use any known technique as appropriate. In the present invention, the terms “dehydration” and “whey separation” are sometimes used with the same meaning. For example, by performing separation of the whey by implementing known techniques such as curd cutting, stirring, cooking, temperature holding, whey separation, matting, milling, salting, mellowing, molding and pressing, the whey can be separated from the mixture of curd and whey to obtain a natural cheese (N) with a moisture content of 35 to 40% by mass relative to the total mass of the curd.

One aspect of the present invention involves separating the whey from the mixture of curd and whey obtained in the coagulation step so as to achieve a moisture content of 35 to 40% by mass relative to the total mass of the curd.

One aspect of the present invention involves performing the aforementioned dehydration step by cooking at least the curd to 55° C. or higher, and preferably 55 to 65° C., and then holding that temperature to inactivate the milk coagulating enzyme. Further, another aspect of the present invention involves performing the aforementioned dehydration step by cooking at least the curd to 55° C. or higher, and preferably 55 to 65° C., at a rate of temperature increase of not more than 1° C. per minute, and then holding that temperature to inactivate the milk coagulating enzyme.

For example, the curd obtained in the coagulation step is subjected to cutting, is subsequently heated, preferably under stirring, to a temperature of at least 55° C., and preferably 55 to 65° C. (cooking), and is then held at that temperature for about 10 to 80 minutes (holding). This step combines inactivation of the milk coagulating enzyme and separation of the whey from the mixture of curd and whey. Provided the cooking temperature is at least 55° C., the milk coagulating enzyme is inactivated, and any decrease in the melting viscosity of the natural cheese (N) can be favorably suppressed. Provided the cooking temperature is not more than 65° C., adhesion or stretching of the curd caused by the cooking is unlikely. Even if the cooking and holding in the dehydration step are performed at a high temperature exceeding 65° C., provided the temperature is cooled rapidly to 65° C. or less following inactivation of the milk coagulating enzyme, unnecessary adhesion and stretching of the curd caused by the cooking can be suppressed.

In the present invention, “inactivation of the milk coagulating enzyme” means degeneration of the milk coagulating enzyme, resulting in loss of its function as a milk coagulating enzyme.

Further, the cooking performed when raising the temperature of the acidified milk to 40° C. or higher is preferably performed gently. For example, when cooking to a temperature of 40° C. to 60° C., the time taken to raise the temperature is preferably at least 20 minutes but not more than 60 minutes, and is more preferably at least 30 minutes but not more than 50 minutes.

In other words, when the acidified milk is heated to a temperature of 40° C. or higher, the rate of temperature increase is preferably at least 0.3° C. but not more than 1° C. per minute, and is more preferably at least 0.4° C. but not more than 0.7° C. per minute. When the rate of temperature increase in the dehydration step is faster than 1° C./minute, dehydration (separation of the whey) from the curd surface is accelerated rapidly, meaning only the curd surface hardens, with dehydration from the curd interior occurring less easily. Consequently, the moisture distribution within the curd becomes non-uniform, and the level of dehydration (whey separation) in the dehydration step tends to be unsatisfactory. As a result, curd formation weakens, and the melting viscosity decreases.

The cooking method is preferably an indirect heating method. In other words, rather than a direct heating method such as steam injection, in which the temperature of the heating medium is high, meaning the temperature can be increased in a short period of time, an indirect heating method which results in more gentle cooking is preferable.

In the present description, the term “indirect heating” or “indirect heating method” means a cooking method in which the heat of the heating medium is transmitted to the cooking target material without the heating medium making direct contact with the cooking target material, thereby cooking the target material by heat exchange. This indirect heaing is performed, for example, by circulating hot water through a jacket of a reaction container such as a tank, thereby cooking the target material inside the reaction container by heat exchange from the heat of the hot water.

The temperature of the hot water can be set as appropriate in accordance with the target temperature for the cooking target material and the desired rate of temperature increase, but is preferably from 60 to 95° C., and more preferably from 65 to 90° C.

The moisture content of the natural cheese (N) obtained in this step is preferably from 35 to 40% by mass relative to the total mass of the natural cheese (N). In other words, in the dehydration step, the operating conditions are preferably set so that the moisture content of the natural cheese (N) obtained upon separation of the whey is from 35 to 40% by mass.

Provided the moisture content is at least 35% by mass, the dehydration step does not become excessively long, and provided the moisture content is not more than 40% by mass, moisture adjustment during production of the processed cheese need not be excessively restricted, which is also desirable.

### [Method of Measuring Moisture Content]

In the present description, the moisture content of the natural cheese refers to the moisture content value obtained using the air oven method (heating at 102° C. until a constant temperature is achieved) prescribed in the international standard methods used for quantifying the milk solids content of cheese by the International Dairy Federation (IDF).

The pH at 25° C. of the natural cheese (N) obtained in this step is preferably from 5.6 to 6.4, and more preferably from 5.9 to 6.2. Provided the pH value is at least as large as the lower limit of the above range, the structure does not become too soft, whereas provided the pH value is not more than the upper limit, adjustment of the moisture content by whey separation proceeds readily.

### <<Production Steps for Processed Cheese>>

Next is a description of the steps for producing a processed cheese using the natural cheese (N).

The method for producing a processed cheese according to the present invention has a cooking and emulsification step of adding an emulsifying salt to an ingredient cheese containing at least one type of natural cheese, and then performing cooking and emulsifying.

If desired, the ingredient cheese may be prepared by adding and mixing a natural cheese other than the natural cheese (N) to the natural cheese (N), and the proportion of the natural cheese (N) within the ingredient cheese may be adjusted to at least 5% by mass relative to the total mass of the ingredient cheese.

<Natural Cheese other than the Natural Cheese (N)>

In addition to the natural cheese (N), a natural cheese other than the natural cheese (N) can also be used as an ingredient cheese for use in the production of the processed cheese. This other natural cheese is a “natural cheese” as prescribed in the Ministerial Ordinance on Milk and Milk products Concerning Compositional Standards, etc.“, and any conventional natural cheese used in the production of processed cheeses can be used as appropriate.

Natural cheeses are classified as soft cheeses, semi-hard cheeses, hard cheeses and special hard cheeses based on their moisture on a fat free basis (MFFB).

The natural cheese (N) in the present invention has an excellent effect in increasing the hardness of the processed cheese, and can be used favorably when a processed cheese is produced using a soft cheese or a cheese which has a weak structure at a comparatively high degree of maturity as the natural cheese other than the natural cheese (N).

### <Emulsifying Salt>

The emulsifying salt used in the production of the processed cheese can employ conventional emulsifying salts typically used in the field of cheeses. A single emulsifying salt may be used, or a combination of two or more emulsifying salts may be used.

Specific examples of the emulsifying salt include phosphate salts, including monophosphate salts (such as sodium orthophosphate), diphosphate salts (such as sodium pyrophosphate) and polyphosphate salts (such as sodium polyphosphate), and citrate salts (such as sodium citrate and potassium citrate).

The amount added of the emulsifying salt is typically from 0.1 to 10% by mass, and preferably from 0.5 to 3% by mass, relative to the total mass of the natural cheese (ingredient cheese) and the emulsifying salt. Provided the amount is at least as large as the lower limit of the above range, emulsification defects are unlikely. Provided the amount is not more than the upper limit, precipitation of crystals of the emulsifying salt during storage is unlikely, and therefore inferior flavor caused by this type of crystal precipitation is also unlikely.

### <Other Components>

When producing a processed cheese, the term “other components” means components that are permissible as components of the processed cheese, for example, additives permissible as food additives. In other words, conventional preservatives, flavorings, thickening agents, gelling agents, emulsifiers other than the emulsifying salt, pH modifiers and fragrances typically used in processed cheese; cream, butter, or butter oil or the like used for adjusting the fat content; auxiliary materials (ingredients), namely foodstuffs added for the purpose of imparting flavor, fragrance, nutrients, functionality or physical properties, such as meats (for example, processed meat products such as salami), fish (for example, processed marine products), vegetables, and ground food products produced by grinding foodstuffs such as plant seeds such as almonds; powdered foods such as shichimi (a blend of chili pepper and other spices) and wasabi; paste-like foodstuffs such as mentaiko (salted cod roe); liquid foodstuffs such as sauces and syrups; and milks other than the aforementioned cream, butter and butter oil may be used, provided they do not impair the effects of the present invention.

These other components may be used individually, or a plurality of components may be selected and used as appropriate.

The combined ingredients for the processed cheese can be prepared by adding, to the natural cheese (N), the emulsifying salt, and optionally, a natural cheese other than the natural cheese (N), water, and any other components permissible as processed cheese components, and then mixing the resulting mixture. In these combined ingredients for the processed cheese, the amount of the natural cheese (N) is at least 5% by mass relative to the total mass of the ingredient cheese composed of the natural cheese (N) and the natural cheese(s) other than the natural cheese (N) which have been optionally added.

### <Cooking and Emulsification Step>

The method for producing a processed cheese according to the present invention has a cooking and emulsification step of adding an emulsifying salt to an ingredient cheese, and then performing cooking and emulsifying.

The ingredient cheese contains at least one type of natural cheese, and includes at least the natural cheese (N) produced using the method described above. The ingredient cheese may be composed only of the natural cheese (N), or may also contain one or more types of natural cheese other than the natural cheese (N).

The proportion of the natural cheese (N) within the ingredient cheese is at least 5% by mass, preferably at least 10% by mass, and still more preferably 20% by mass, relative to the total mass of the ingredient cheese. This proportion may be 100% by mass, but in terms of making it easier to obtain a processed cheese having good flavor, a proportion of not more than 50% by mass is preferable. In other words, the proportion of the natural cheese (N) relative to the total mass of the ingredient cheese is preferably at least 5% by mass but not more than 100% by mass, more preferably at least 10% by mass but not more than 100% by mass, still more preferably at least 20% by mass but not more than 100% by mass, still more preferably at least 5% by mass but not more than 50% by mass, and particularly preferably at least 20% by mass but not more than 50% by mass.

In the combined ingredients for the processed cheese, the amount of the ingredient cheese is preferably at least 20% by mass but not more than 95% by mass, more preferably at least 50% by mass but not more than 90% by mass, and still more preferably at least 60% by mass but not more than 80% by mass, relative to the total mass of the combined ingredients for the processed cheese.

The natural cheese (N) obtained in the aforementioned dehydration step may be used immediately following production in the production of the processed cheese, but in terms of facilitating structural stability and ease of handling, the natural cheese (N) is preferably stored at 10° C. or lower for a period of 10 to 180 days before being used in the cooking and emulsification step. This storage period is more preferably from 30 to 90 days.

In one aspect of the present invention, in the cooking and emulsification step, combined ingredients for the processed cheese containing an ingredient cheese and an emulsifying salt, and optionally, containing one or more additives and auxiliary materials, is subjected to cooking and emulsification. If necessary, a water solvent may be included in the combined ingredients. The ingredient cheese preferably employs a ground product that has been ground in advance.

In another aspect of the present invention, the method for producing a processed cheese includes a cooking and emulsification step of adding an emulsifying salt, and optionally another natural cheese other than the natural cheese (N), to the natural cheese (N), mixing the resulting mixture, and then performing cooking and emulsification.

In yet another aspect of the present invention, the method for producing a processed cheese includes a step of preparing combined ingredients for the processed cheese by adding, to the natural cheese (N), an emulsifying salt, and optionally, another natural cheese other than the natural cheese (N), water and other components permissible as processed cheese components, and then mixing the resulting mixture, and a cooking and emulsification step of cooking and emulsifying the combined ingredients for the processed cheese.

Specifically, in the cooking and emulsification step, the above combined ingredients are placed in a cooker and subjected to cooking and emulsification. The cooking and emulsification is a step of performing a cooking treatment while stirring the combined ingredients, and also functions as a pasteurization step. The cooking treatment is preferably conducted using direct or indirect steam. Examples of cookers that may be used include kettle type cookers, cookers having a biaxial screw, and thermo cylinder type cookers.

There are no particular limitations on the cooking and emulsifying conditions. For example, a cooked and emulsified product of the combined ingredients can be obtained by stirring the ingredients with a stirrer at a rate of 100 to 1,500 rpm, while performing cooking and emulsifying as well as satisfying prescribed heat pasteurization conditions, and then finishing the emulsification process.

The cooking temperature is preferably at least 70° C., and more preferably from 80 to 90° C. By holding the ingredients within this cooking temperature range for a period of 3 to 1,200 seconds, and preferably 5 to 900 seconds, heat pasteurization conditions for the combined ingredients can be satisfied.

By molding and cooling the cooked and emulsified product obtained in the cooking and emulsification step using normal methods, a processed cheese can be obtained.

In the method for producing a processed cheese according to the present invention, because the natural cheese (N) produced using the specific method described above does not require the addition of a lactic acid bacterium starter in the production steps, and is subjected to an inactivation step for the milk coagulating enzyme, casein degradation is unlikely to proceed during storage of the natural cheese (N).

Accordingly, casein degradation during storage has conventionally been suppressed using a method in which the enzyme activity is reduced by lowering the moisture content of the natural cheese (N), a method in which the moisture activity is reduced by increasing the salt concentration of the natural cheese (N), or a method in which the storage temperature is set lower than normal refrigeration temperature (for example, 0 to -2° C.), thereby reducing microbe growth and enzyme activity, but even without using these methods, casein degradation during storage of the natural cheese (N) can be favorably suppressed, and any decrease in the melting viscosity can be favorably suppressed.

The larger the amount of non-degraded casein (intact casein) within the natural cheese (N), the higher the melting viscosity of the natural cheese (N), and the larger the effect of the natural cheese (N) in increasing the hardness of the processed cheese.

In the present invention, the melting viscosity of the natural cheese (N) is preferably at least 2,500 mPa·s but not more than 100,000 mPa·s when 77 parts by mass of the ground natural cheese (N) is precooked at 50° C., 21 parts by mass of water and 2 parts by mass of trisodium citrate are then added, the resulting mixture is stirred while undergoing cooking and melting by raising the temperature at a rate that increases the temperature from 50° C. to 90° C. in about 3 minutes, and the 90° C. temperature is then held for 12 minutes. In the case of a natural cheese (N) for which the storage period in an environment at 5° C. is not more than 90 days (3 months), the melting viscosity is preferably at least 3,000 mPa·s but not more than 100,000 mPa·s, whereas in the case of a natural cheese (N) for which the storage period in an environment at 5° C. is not more than 30 days (1 month), the melting viscosity is preferably at least 3,500 mPa·s but not more than 100,000 mPa·s.

A processed cheese obtained using this type of natural cheese (N) for at least a portion of the ingredient cheese is imparted with favorable hardness as a result of the natural cheese (N). Further, because any decrease in the melting viscosity of the natural cheese (N) upon storage is favorably suppressed, the production stability of the processed cheese is excellent.

Moreover, because the natural cheese is produced without using a lactic acid bacterium starter, the risk of infection due to bacteriophage can be avoided.

The hardness of the processed cheese produced by the production method of the present invention is preferably from 0.1 to not more than 60 N, and more preferably from 0.1 to not more than 40 N.

In the present description, the hardness of the processed cheese can be measured by typical methods, using a rheometer as a measuring device. Specifically, for a measurement sample prepared by holding a sheet of processed cheese with a thickness of 2.0 mm at 5° C. for 3 hours, the maximum load observed when a rheometer (Creep Meter RE2-330055, manufactured by Yamaden Co., Ltd.) is used to force a circular plunger with a diameter of 8 0 mm through the measurement sample at a penetration rate of 10 mm/s can be measured as the hardness.

Further, the present invention may also adopt the following configurations.

(1) A method for producing a processed cheese including:

an acidification step of adding an acid component to a milk to adjust the pH to a value of 5.8 to 6.4, thereby obtaining an acidified milk having a pH of 5.8 to 6.4;

a coagulation step of adding a milk coagulating enzyme to the acidified milk, without adding a lactic acid bacterium starter, thereby coagulating the milk and obtaining a curd;

a dehydration step of obtaining a natural cheese (N) by inactivating the milk coagulating enzyme by cooking the curd to at least 55° C. at a rate of temperature increase of not more than 1° C. per minute, while separating the whey from the mixture of the curd and whey;

a step of preparing an ingredient cheese containing at least 5% by mass of the natural cheese (N) relative to the total mass of the ingredient cheese; and

a cooking and emulsification step of adding an emulsifying salt to the ingredient cheese and performing cooking and emulsification.

(2) A method for producing a processed cheese including:

an acidification step of adding an acid component to a milk to adjust the pH to a value of 5.8 to 6.4, thereby obtaining an acidified milk having a pH of 5.8 to 6.4;

a coagulation step of adding a milk coagulating enzyme to the acidified milk, without adding a lactic acid bacterium starter, thereby coagulating the milk and obtaining a curd;

a dehydration step of obtaining a natural cheese (N) by inactivating the milk coagulating enzyme by cooking the curd to at least 55° C. at a rate of temperature increase of not more than 1° C. per minute, while separating the whey from the mixture of the curd and whey;

a step of preparing combined ingredients for the processed cheese by adding, to the natural cheese (N), an emulsifying salt, and optionally, a natural cheese other than the natural cheese (N), water, and any other components permissible as processed cheese components, and then mixing the resulting mixture; and

a cooking and emulsification step of cooking and emulsifying the combined ingredients for the processed cheese, wherein

in the combined ingredients for the processed cheese, the amount of the natural cheese (N) is at least 5% by mass relative to the total mass of the ingredient cheese composed of the natural cheese (N) and the natural cheese other than the natural cheese (N) that has been optionally added.

### EXAMPLES

The present invention is described below in further detail using a series of examples, but the present invention is in no way limited by these examples.

### Example 1 to Example 4

First, a raw cow's milk (having a pH at 25° C. of 6.7) was subjected to heat pasteurization by holding at 72° C. for 15 seconds to obtain a pasteurized milk, and the temperature of the milk was then adjusted to 40° C. Subsequently, an aqueous solution of citric acid with a concentration of 10% by mass was added to the pasteurized milk at 40° C. so as to achieve the pH value shown in Table 1, and the resulting mixture was stirred to obtain an acidified milk.

Calcium chloride was added to the obtained acidified milk (40° C.) in an amount sufficient to produce a concentration (by volume) within the acidified milk of 60 ppm, and the resulting mixture was stirred.

Ten minutes after the addition of the aqueous solution of citric acid, an aqueous solution of rennet (product name: Fromase XLG, manufactured by DSM N.V., strength: 750 IMCU/mL) was added to the acidified milk (40° C.) in an amount sufficient to produce a rennet concentration (by volume) within the acidified milk of 25 ppm, and was dispersed uniformly.

The temperature and the pH of the acidified milk when the rennet was added are shown in Table 1.

The acidified milk containing the added aqueous solution of rennet was left to stand and coagulate while the temperature was held at 40° C. Thirty minutes after the addition of the aqueous solution of rennet, the curd (40° C.) was cut, and the temperature was then increased to 60° C. (the cooking temperature for the dehydration step) over a period of 40 minutes with constant stirring. The increase in temperature was achieved by an indirect heating method using heat exchange in which hot water of 66° C. was circulated through a jacket provided around the side surfaces of the tank containing the acidified milk.

The acidified milk was then held at 60° C. for 40 minutes under stirring. The cut curd obtained in this manner was matted, milled, and salted (2.8% by mass relative to the total mass of the mixture of curd and whey) using conventional methods, and following mellowing, the mixture was molded and pressed to separate the whey, thus obtaining a natural cheese (N). The cooking temperature in the dehydration step, and the moisture content and pH at 25° C. of the obtained natural cheese (N) are shown in Table 1.

The thus obtained natural cheese (N) was stored in an incubator at 5° C.

The natural cheese (N) obtained in each of the examples was stored for 1 month, 2 months, 3 months or 6 months in an incubator at 5° C., and was then used to produce a processed cheese.

The composition of the combined ingredients was composed of 77% by mass of the natural cheese (N), 21% by mass of water, and 2% by mass of the emulsifying salt trisodium citrate. A cooker fitted with a viscosity measurement device (product name: Rapid Visco Analyzer, manufactured by Newport Scientific Pty. Ltd.) was used as the cooker.

First, the ground natural cheese (N) was placed in the cooker and precooked at 50° C. The water and the emulsifying salt were then added, and with the resulting mixture undergoing constant stirring, the natural cheese (N) was subjected to cooking and melting by raising the temperature at a rate that increased the temperature from 50° C. to 90° C. in about 3 minutes, and then holding the temperature at 90° C. for 12 minutes. The viscosity 12 minutes after the temperature reached 90° C. is shown in Table 1.

Twelve minutes after the temperature reached 90° C., the cooking was halted, and the product was cooled to 5° C. in a refrigerator to obtain a processed cheese.

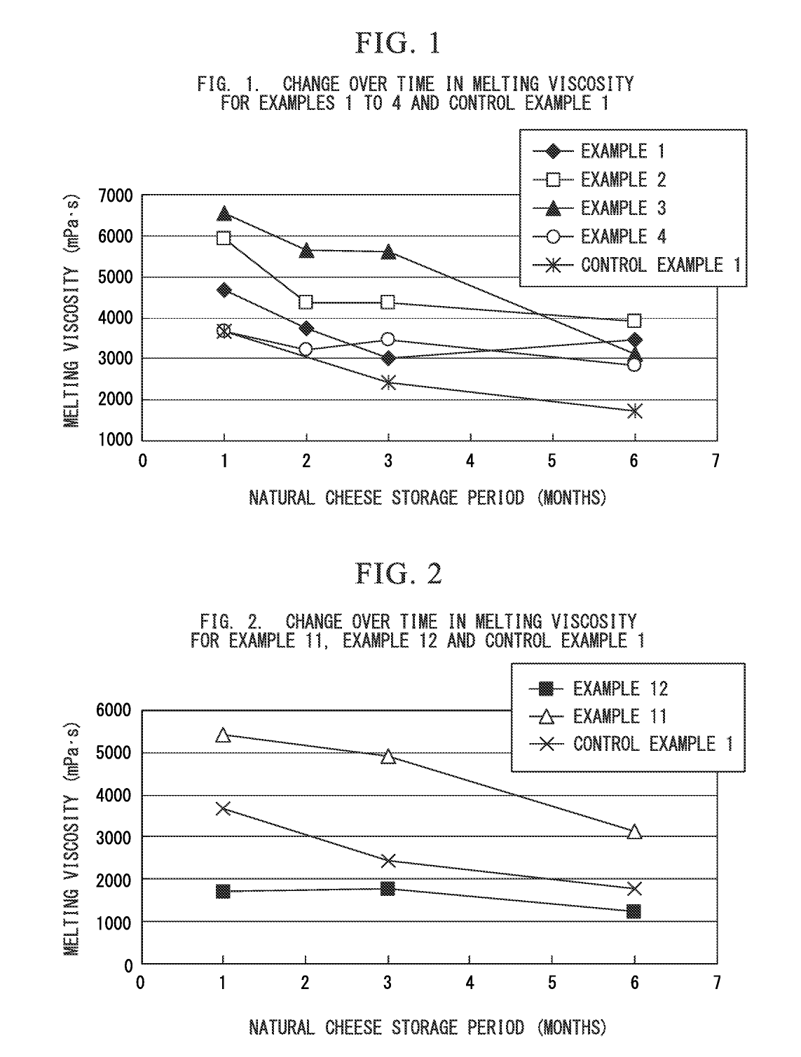

FIG. 1 is a diagram illustrating the viscosity measurement results shown in Table 1 as a graph, wherein the horizontal axis represents the storage period (units: months) for which the natural cheese was stored in the incubator at 5° C.

### Example 5

In Example 1, the aqueous solution of citric acid with a concentration of 10% by mass was added to the pasteurized milk at 40° C. to achieve a pH of 5.6, and the resulting mixture was stirred to obtain an acidified milk. Calcium chloride was added to this acidified milk in the same manner as Example 1, but when the aqueous solution of rennet was added and the mixture was left to stand and coagulate while the temperature was held at 40° C., the coagulation was poor, and the whey remained very cloudy. Accordingly, the subsequent operations were not performed.

### Test Example 1

In this example, a natural cheese was produced by a conventional method using a lactic acid bacterium starter as a Control Example 1.

First, a raw cow's milk (having a pH at 25° C. of 6.7) was subjected to heat pasteurization by holding at 72° C. for 15 seconds to obtain a pasteurized milk, and the temperature of the milk was then adjusted to 32° C.

Calcium chloride was added to the pasteurized milk (32° C.) in an amount sufficient to produce a concentration (by volume) within the pasteurized milk of 60 ppm, and the resulting mixture was stirred.

Subsequently, a lactic acid bacterium (manufactured by Chr. Hansen A/S) was added, and the pasteurized milk was acidified by fermenting the mixture for about 50 minutes. The same aqueous solution of rennet as that used in Example 1 was added in an amount sufficient to produce a concentration (by volume) of 100 ppm, and was dispersed uniformly. In this example, because the temperature of the milk was lower than the previous examples, the rennet concentration (by volume) was set to 100 ppm.

The temperature and the pH of the acidified milk when the rennet was added are shown in Table 1.

The acidified milk containing the added aqueous solution of rennet was left to stand and coagulate while the temperature was held at 32° C. Thirty minutes after the addition of the aqueous solution of rennet, the curd (32° C.) was cut, the temperature was increased to 38° C. over a period of 40 minutes with constant stirring, and the temperature was then held at 38° C. for a period of 80 minutes with constant stirring. The holding time at 38° C. was set to 80 minutes to reduce the moisture content of the obtained natural cheese to 33.5% by mass. The reason that the moisture content of the natural cheese was lowered to 33.5% by mass in this example was to suppress the activity of the enzyme during storage.

The curd (38° C.) obtained in this manner was matted, milled, and salted (2.8% by mass relative to the total mass of the mixture of curd and whey) using conventional methods, and following mellowing, the mixture was molded and pressed to separate the whey, thus obtaining a natural cheese (38° C.). The moisture content of the obtained natural cheese is shown in Table 1.

The thus obtained natural cheese (N) was stored in an incubator at 5° C.

In a similar manner to Example 1, the natural cheese obtained in this example was stored for 1, 3 or 6 months in an incubator at 5° C., and was then used to produce a processed cheese.

In a similar manner to Example 1, the viscosity was measured in the cooking and melting step, 12 minutes after a temperature of 90° C. had been reached. The measurement results are shown in Table 1 and FIG. 1.

TABLE 1
Various Measurements for Examples 1 to 4 and Control Example 1

| | | Example | Example | Example | Example | Control |
|---|---|---|---|---|---|---|
| | | 1 | 2 | 3 | 4 | Example 1 |
| Acidification step | Acidified milk temperature [° C.] | 40 | 40 | 40 | 40 | 32 |
| | Acidified milk pH | 5.8 | 6 | 6.2 | 6.4 | 6.7 |
| Dehydration step | Cooking temperature [° C.] | 60 | 60 | 60 | 60 | 38 |
| Natural cheese (N) | Moisture content [mass %] | 37.99 | 35.6 | 35.3 | 36.77 | 33.5 |
| | pH (25° C.) | 5.7 | 5.9 | 6.1 | 6.3 | 5.4 |
| Melting viscosity of | after 1 month storage | 4690 | 5930 | 6536 | 3666 | 3670 |
| Natural cheese (N) | after 2 months storage | 3754 | 4367 | 5642 | 3230 | — |
| [mPa · s] | after 3 months storage | 3008 | 4353 | 5597 | 3448 | 2429 |
| | after 6 months storage | 3464 | 3910 | 3116 | 2834 | 1741 |

Based on the results of Table 1 and FIG. 1, it was evident that in Control Example 1, in which a natural cheese was produced by a conventional method of adding a lactic acid bacterium starter and a rennet to a milk to form a curd, and the resulting natural cheese was then stored in an environment that suppressed degradation of the casein, the melting viscosity when the natural cheese was subsequently cooked and melted decreased as the storage period was lengthened, with the melting viscosity falling below 2500 mPa·s after 3 months storage, and falling below 2000 mPa·s after 6 months storage.

When the melting viscosity of the natural cheese upon cooking and melting decreases, the hardness of the obtained processed cheese also decreases.

On the other hand, in Examples 1 to 4 in which natural cheeses were produced using the method of the present invention, the decrease in the melting viscosity of the natural cheese as the storage period was lengthened was less than that observed in Control Example 1, and the stability of the physical properties over time was excellent. For example, in the case of Example 4, which exhibited a substantially similar melting viscosity to the Control Example after only 1 month storage following production, the melting viscosity after 3 months storage was 3448 mPa·s, which represents about 1.4 times the melting viscosity of 2429 mPa·s observed for Control Example 1 after the same storage period, indicating a significant difference. Moreover, after 6 months storage, the melting viscosity of Example 4 was 2834 mPa·s, which compared with the melting viscosity of 1741 mPa·s for Control Example 1 after the same storage period, represents an even greater difference of about 1.6 times. Further, the melting viscosities of Examples 1 to 3 after 3 months storage were about 1.2 times, about 1.8 times and about 2.3 times respectively larger compared with the melting viscosity of the Control Example after the same storage period. Moreover, the melting viscosities of Examples 1 to 3 after 6 months storage were about 2.0 times, about 2.2 times and about 1.8 times respectively larger compared with the melting viscosity of the Control Example after the same storage period.

### Examples 11 to 13

In Example 11, a natural cheese (N) was produced in the same manner as Example 2.

In Example 12, with the exception of changing the cooking temperature in the dehydration step to 50° C., a natural cheese (N) was produced in the same manner as Example 11.

In other words, in Example 12, 30 minutes after the addition of the aqueous solution of rennet, the curd (40° C.) was cut, and the temperature was then increased to 50° C. over a period of 40 minutes with constant stirring. This temperature of 50° C. was then held for a further 40 minutes while stirring was continued.

The thus obtained natural cheese (N) was stored in an incubator at 5° C.

In a similar manner to Example 1, the natural cheese (N) obtained in each example was stored for 1, 3 or 6 months in a refrigerator at 5° C., and was then used to produce a processed cheese.

In a similar manner to Example 1, the viscosity was measured in the cooking and melting step, 12 minutes after a temperature of 90° C. had been reached. The measurement results are shown in Table 2 and FIG. 2.

Further, the results for the aforementioned Control Example 1 are also shown in FIG. 2.

TABLE 2
Various Measurements for Example 11, Example 12 and Control Example 1

| | | | Example 12 | |
|---|---|---|---|---|
| | | Example 11 | (Comparative | Control |
| | | (Example 2) | Example) | Example 1 |
| Acidification step | Acidified milk temperature [° C.] | 40 | 40 | 32 |
| | Acidified milk pH | 6 | 6 | 6.7 |
| Dehydration step | Cooking temperature [° C.] | 60 | 50 | 38 |
| Natural cheese (N) | Moisture content [mass %] | 38.62 | 39.83 | 33.5 |
| | pH (25° C.) | 5.9 | 6 | 5.4 |
| Melting viscosity of | after 1 month storage | 5453 | 1700 | 3670 |
| Natural cheese (N) | after 3 months storage | 4919 | 1763 | 2429 |
| [mPa · s] | after 6 months storage | 3125 | 1215 | 1741 |

Based on the results of Table 2 and FIG. 2, it was evident that in Example 11, in which the curd was cooked at 60° C. in the dehydration step, the decrease in the melting viscosity of the natural cheese was smaller than that observed for Control Example 1.

In contrast, in Example 12 in which the curd was cooked at 50° C. in the dehydration step, the melting viscosity of the natural cheese after storage for 1 month was 1700 mPa·s, much lower than, and only about 0.46 times, the melting viscosity of 3670 mPa·s of Control Example 1 after the same storage period, although when the storage period was lengthened, the melting viscosity of the natural cheese did not change significantly. It is thought that degradation of the casein proceeded rapidly in the first month after starting the storage period. Although the natural cheese (N) was produced under the same conditions in Example 11 and Example 2, there was a difference in the moisture content values of the obtained natural cheeses (N). This difference was within the range expected due to differences in the raw milk used and production variations during cutting and matting.

### Test Example 2

In this example, as a Control Example 2, a natural cheese was produced in accordance with the method disclosed in Example 1 of the related art Patent Document 3, by cooking the cheese curd using a direct heating method. First, a raw cow's milk (having a pH at 25° C. of 6.7) was subjected to heat pasteurization by holding at 72° C. for 15 seconds to obtain a pasteurized milk, and the temperature of the milk was then adjusted to 40° C. Subsequently, an aqueous solution of acetic acid with a concentration of 50% by mass was added to the pasteurized milk at 40° C. to adjust the pH to 6.2, and the resulting mixture was stirred to obtain an acidified milk.

An aqueous solution of rennet (product name: Fromase XLG, manufactured by DSM N.V., strength: 750 IMCU/mL) was added to the acidified milk (40° C.) in an amount sufficient to produce a rennet concentration (by volume) within the acidified milk of 90 ppm, and the resulting mixture was stirred for one minute to achieve uniform dispersion. The temperature and pH of the acidified milk upon addition of the rennet are shown in Table 3. In this example, because the coagulation time was shorter than that of Examples 1 to 4, the amount of rennet added was adjusted so that the hardness of the curd prior to cooking was similar to that observed in Examples 1 to 4.

Stirring was halted, and the acidified milk containing the added aqueous solution of rennet was left to stand and coagulate for 5 minutes while the temperature was held at 40° C. Subsequently, the curd was cut with a wire cutter, and following standing for a further 5 minutes, the whey was separated. Using a steam injection direct heating method, the curd (40° C.) was heated to 63° C. (the cooking temperature in the dehydration step) over a period of 10 minutes (rate of temperature increase: 2.3° C./minute). Once the temperature had reached 63° C., the temperature was cooled rapidly to 40° C. under stirring to prevent adhesion of the curd, and the whey was separated.

The thus obtained curd was matted, milled, and salted (2.3% by mass relative to the total mass of the mixture of curd and whey) using conventional methods, and citric acid was then added (in an amount of 1.0% by mass relative to the total mass of the mixture of curd and whey). It was noted that the amount of whey separated upon matting, milling and salting in the production method of this example was markedly greater than the amounts observed during production of the natural cheeses (N) of Examples 1 to 4 according to the present invention. It was assumed that the separation of whey during the dehydration step was inadequate.

The curd obtained in this manner was split, with 550 g of the curd placed in each of three molds, and the curd was then molded and pressed to obtain a natural cheese. The average weight of the three natural cheeses was 446 g (n=3), with 104 g of salt whey (whey separated after salting) separated during the pressing step. In other words, about 19% by mass of the curd placed in the mold was removed during the pressing step.

When the natural cheeses (N) were produced in Examples 1 to 4 according to the present invention, the salt whey separated during pressing was about 8% by mass of the curd placed in the mold.

These results also suggest that in the production method of the present example, the separation of whey during the dehydration step was inadequate, indicating that the moisture in the curd obtained following the dehydration step was dispersed in a non-uniform manner. It is thought that this is because only the surface of the curd hardened due to the fact that the rate of temperature increase in the dehydration step was too rapid. The cooking temperature and rate of temperature increase in the dehydration step, the amount of salt whey separated in the pressing step, and the moisture content and the pH at 25° C. of the obtained natural cheese are all shown in Table 3.

The obtained natural cheese was stored in an incubator at 5° C., and after 1 month, processed cheese production was performed using the same cooking and melting step as that described for Example 1, and the viscosity was measured 12 minutes after a temperature of 90° C. was reached. The measurement result is shown in Table 3, together with the melting viscosity following 1 month storage for Example 3 according to the present invention.

The result for the melting viscosity of the present example was a low viscosity of 1570 mPa·s, which was markedly lower than, and only about 0.24 times, the viscosity of 6536 mPa·s observed after the same storage period for Example 3, which was also produced so that the pH of the acidified milk was 6.2. As a result, no further storage was performed.

TABLE 3
Various Measurements for Example 3 and Control Example 2

| | | Control Example 2 | Example 3 |
|---|---|---|---|
| Acidification step | Acidified milk temperature [° C.] | 40 | 40 |
| | Acidified milk pH | 6.2 | 6.2 |
| Dehydration step | Cooking method | Direct heating | Indirect heating |
| | Cooking temperature [° C.] | 63 | 60 |
| | Rate of temperature increase [° C./min] | 2.3 | 0.5 |
| Pressing step | Amount of salt whey separated relative | 19 | 8 |
| | to amount of molded curd [mass %] | | |
| Natural cheese | Moisture content [mass %] | 38.8 | 35.3 |
| | pH (25° C.) | 5.3 | 6.1 |

| | | |
|---|---|---|
| Melting viscosity of natural cheese (after 1 month storage) | 1570 | 6536 |
| [mPa · s] | | |

### Working Example 1

Processed cheeses were produced using the natural cheeses (N) obtained in Examples 1 to 4 which had been stored for 3 months in a refrigerator at 5° C.

A cheddar cheese made in Oceania having a weak structure at a comparatively high degree of maturity was used as a natural cheese other than the natural cheese (N).

The composition of the combined ingredients, relative to the total mass of the combined ingredients, included 30% by mass of the natural cheese (N), 50% by mass of the Oceania cheddar cheese, 17% by mass of water, and 3% by mass of trisodium citrate as the emulsifying salt. The proportion of the natural cheese (N) within the ingredient cheese was 37.5% by mass. A kettle type cooker was used as the cooker.

First, the ground natural cheese (N) and Oceania cheddar cheese were placed in the cooker. The water and the emulsifying salt were then added, and with the mixture undergoing constant stirring, the temperature as raised from 50° C. to 80° C. over a period of 3 minutes, and then held at 80° C. for a further one minute. The cooking was then halted, and the product was immediately packed into a carton and cooled in a refrigerator at 5° C. to obtain a processed cheese.

### INDUSTRIAL APPLICABILITY

According to the present invention, a natural cheese can be obtained which has a high melting viscosity when subjected to cooking and melting and is resistant to any decrease in the melting viscosity during storage, and by producing a processed cheese using this natural cheese, a processed cheese having favorable hardness can be produced with good stability. Further, because a natural cheese can be produced without using a lactic acid bacterium starter, the risk of infection due to bacteriophage can be avoided even if a step of performing heat pasteurization is not provided following curd formation.

1. A method for producing a processed cheese comprising a cooking and emulsification step of adding an emulsifying salt to an ingredient cheese containing at least one type of natural cheese and then performing cooking and emulsifying, in which
a natural cheese (N) is produced via an acidification step, a coagulation step and a dehydration step described below, and
the cooking and emulsification step is performed using the obtained natural cheese (N) for at least 5% by mass of the ingredient cheese, wherein the acidification step is a step of acidifying a milk to obtain an acidified milk having a pH of 5.8 to 6.4, in which an acid component is added to the milk to achieve the pH for the acidified milk,
the coagulation step is a step of obtaining a curd by adding a milk coagulating enzyme to the acidified milk to cause coagulation, without adding a lactic acid bacterium starter, and
the dehydration step is a step of obtaining the natural cheese (N) by separating whey from the curd, and comprises an enzyme inactivation step of inactivating the milk coagulating enzyme by cooking the curd to at least 55° C. at a rate of temperature increase of not more than 1° C. per minute.

2. The method for producing a processed cheese according to claim 1, wherein in the dehydration step, separation of the whey is performed so that a moisture content of the obtained natural cheese (N) is from 35 to 40% by mass relative to a total mass of the natural cheese (N).

3. The method for producing a processed cheese according to claim 1, wherein the cooking performed in the dehydration step is indirect heating.

4. The method for producing a processed cheese according to claim 1, wherein an inactivation temperature for the milk coagulating enzyme is from 55 to 65° C.

5. The method for producing a processed cheese according to claim 1, wherein the acid component is an aqueous solution of one or more organic acids selected from the group consisting of citric acid, lactic acid and acetic acid.

6. The method for producing a processed cheese according to claim 1, wherein a pH at 25° C. of the natural cheese (N) obtained in the dehydration step is from 5.6 to 6.4.

7. The method for producing a processed cheese according to claim 1, wherein the cooking and emulsifying is performed after the natural cheese (N) obtained in the dehydration step has been stored at a temperature of not more than 10° C. for 10 to 180 days.
